(19) United States
(12) Patent Application Publication
(10) Pub. No.: US 2020/0272951 A1
(43) Pub. Date: Aug. 27, 2020

(54) OPERATION SUPPORT DEVICE, VEHICLE, OPERATION MANAGEMENT DEVICE, AND OPERATION SUPPORT METHOD

(71) Applicant: TOYOTA JIDOSHA KABUSHIKI KAISHA, Toyota-shi (JP)

(72) Inventors: Taiki YOSHIDA, Tokyo (JP); Saiko TOYODA, Nagoya-shi (JP)

(73) Assignee: TOYOTA JIDOSHA KABUSHIKI KAISHA, Toyota-shi (JP)

(21) Appl. No.: 16/749,651

(22) Filed: Jan. 22, 2020

(30) Foreign Application Priority Data
Feb. 26, 2019 (JP) 2019-033374

(51) Int. Cl. G06Q 10/02; G01C 21/34

(52) U.S. Cl. CPC G06Q 10/02; G01C 21/3438

(57) ABSTRACT

An operation support device is an operation support device for supporting an operation of a vehicle for which an operation plan is determined in accordance with a boarding position and a getting-off position requested by a reservation. The operation support device includes a controlling portion configured such that, when one candidate destination is selected by a person who boards the vehicle at the boarding position from information on a plurality of candidate destinations that is output in the vehicle stopping at the boarding position, the controlling portion acquires information on the one candidate destination thus selected and compares the acquired information with information on the getting-off position that is associated with information on the boarding position at the time of making the reservation.

### INCORPORATION BY REFERENCE

The disclosure of Japanese Patent Application No. 2019-033374 filed on Feb. 26, 2019 including the specification, drawings and abstract is incorporated herein by reference in its entirety.

### BACKGROUND

### 1. Technical Field

The present disclosure relates to an operation support device, a vehicle, an operation management device, and an operation support method.

### 2. Description of Related Art

Japanese Unexamined Patent Application Publication No. 2017-167942 (JP 2017-167942 A) describes a technique to propose a moving route using a vehicle to be provided by a transport vehicle provider as a moving route from a departure place designated by a user to a destination designated by the user and to arrange a vehicle that achieves a moving route accepted by the user as an actual moving route.

### SUMMARY

There is an on-demand traffic system such as an on-demand bus for which an operation plan such as a travel route and an operation schedule is determined in accordance with boarding and getting-off positions and boarding and getting-off times requested by a reservation of a user. In such a traffic system, when a person boards a vehicle, it is necessary to check whether the person is the user who has made the reservation.

In the technique described in JP 2017-167942 A, boarding of the user planned to board the vehicle is checked based on whether a tag ID of the user can be acquired or not. Accordingly, the user should carry a wireless tag. Here, “ID” is an abbreviation of Identifier.

An object of the present disclosure is to provide a technique in which, when a person boards a vehicle, whether the person is a user who has made a reservation or not is checked regardless of whether the person carries communications equipment such as a wireless tag or not.

An operation support device according to one aspect of the present disclosure is an operation support device for supporting an operation of a vehicle for which an operation plan is determined in accordance with a boarding position and a getting-off position requested by a reservation. The operation support device includes a controlling portion configured such that, when one candidate destination is selected or input by a person who boards the vehicle at the boarding position in the vehicle stopping at the boarding position, the controlling portion acquires information on the one candidate destination thus selected or input and compares the acquired information with information on the getting-off position that is associated with information on the boarding position at the time of making the reservation.

An operation management device according to one aspect of the present disclosure is an operation management device including a communication portion and a controlling portion. The communication portion is configured to transmit and receive information. The controlling portion is configured to receive, through the communication portion, position information of a vehicle for which an operation plan is determined in accordance with a boarding position and a getting-off position requested by a reservation, the position information of the vehicle being transmitted from the vehicle during stop at the boarding position, the controlling portion being configured to transmit, through the communication portion in response to the position information of the vehicle, information on the getting-off position that is associated with information on the boarding position corresponding to the position information of the vehicle at the time of making the reservation and information on a plurality of candidate destinations including information on a candidate destination corresponding to the getting-off position.

An operation support method according to one aspect of the present disclosure is an operation support method including: outputting information on a plurality of candidate destinations by a vehicle for which an operation plan is determined in accordance with a boarding position and a getting-off position requested by a reservation, the information being output by the vehicle during stop at the boarding position; when one candidate destination is selected by a person who boards the vehicle at the boarding position from the information output by the vehicle, acquiring, by an operation support device, information on the one candidate destination thus selected; and comparing, by the operation support device, the information thus acquired with information on the getting-off position that is associated with information on the boarding position at the time of making the reservation.

With one aspect of the present disclosure, when a person boards a vehicle, it is possible to check whether the person is a user who has made a reservation or not, regardless of whether the person carries communications equipment such as a wireless tag or not.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic view illustrating a configuration of an on-demand traffic system according to a first embodiment and a second embodiment;

FIG. 2 is a block diagram illustrating the configuration of the on-demand traffic system according to the first embodiment and the second embodiment;

FIG. 3 is a flowchart illustrating an operation of the on-demand traffic system according to the first embodiment;

FIG. 4 is a table illustrating an example of a database according to the first embodiment;

FIG. 5 is a flowchart illustrating an operation of the on-demand traffic system according to the first embodiment;

FIG. 6 is a table illustrating an example of a selection screen according to the first embodiment;

FIG. 7 is a table illustrating an example of a selection screen according to one modification of the first embodiment;

FIG. 8 is a flowchart illustrating an operation of the on-demand traffic system according to the second embodiment;

FIG. 9 is a table illustrating an example of a database according to the second embodiment;

FIG. 10 is a flowchart illustrating an operation of the on-demand traffic system according to the second embodiment; and

FIG. 11 is a table illustrating an example of a selection screen according to the second embodiment.

### DETAILED DESCRIPTION OF EMBODIMENTS

Embodiments will be described below with reference to the drawings.

The same or equivalent portions in the drawings have the same sign. In the following description of each embodiment, in terms of the same or equivalent portions, descriptions are omitted or simplified appropriately.

### First Embodiment

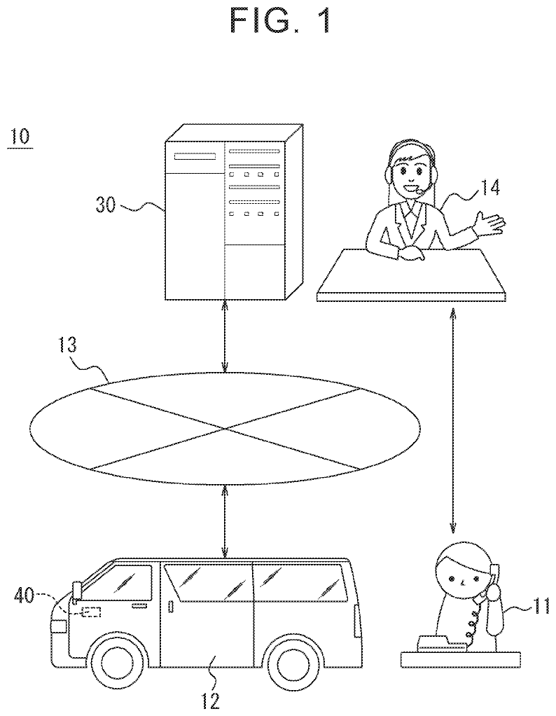

With reference to FIG. 1, the outline of the present embodiment will be described below.

In an on-demand traffic system 10 according to the present embodiment, an operation plan of a vehicle 12 is determined in accordance with a boarding position and a getting-off position requested by a reservation. The vehicle 12 outputs information on a plurality of candidate destinations during stop at the boarding position. An operation management device 30 transmits, to an operation support device 40 at a given point of time, information on the getting-off position that is associated with information on the boarding position at the time of making the reservation. When one candidate destination is selected by a person who boards the vehicle 12 at the boarding position from the information output in the vehicle 12, the operation support device 40 acquires information on the candidate destination thus selected. The operation support device 40 compares the information thus acquired with the information on the getting-off position that is associated with the information on the boarding position at the time of making the reservation.

With the present embodiment, when a person boards a vehicle, it is possible to check whether the person is a user 11 who has made a reservation or not, regardless of whether the person carries communications equipment such as a wireless tag or not.

In the present embodiment, the user 11 makes a reservation for the vehicle 12 by communicating, by telephone or e-mail, with an operator 14 who can access the operation management device 30. However, the user 11 may make a reservation for the vehicle 12 by accessing the operation management device 30 from a terminal device such as a mobile phone device, a smartphone, a tablet, or a PC without communicating with the operator 14. Here, “PC” is an abbreviation of Personal Computer.

In the present embodiment, the communications equipment of the person who has boarded the vehicle 12 is not requested to show an ID, but the person who has boarded the vehicle 12 is directly requested to show secret information that only the person knows. With the present embodiment, it is not necessary for the user 11 to carry the communications equipment, so that the convenience improves. Since it is not necessary for the vehicle 12 to communicate with the communications equipment of the user 11, the facility can be simplified.

In the present embodiment, as the secret information, the user 11 is not requested to show information such as a reservation number or a passcode that the user 11 might forget, but the user 11 is requested to show information on a destination that the user 11 never forgets for boarding. In the present embodiment, it is not necessary for the user 11 to remember the information that the user 11 might forget, so that the convenience improves. Since the operator 14 does not need to notify the user 11 of a reservation number or ask the user 11 about a passcode at the time when the user 11 makes a reservation, the service can be made more efficient.

In the present embodiment, as key information associated with the secret information, information on a boarding position that can be acquired by the vehicle 12 itself is used instead of information such as an ID that is necessary to be acquired from the communications equipment of the person who boards the vehicle 12. In the present embodiment, it is not necessary for the user 11 to carry the communications equipment, so that convenience improves. Since it is not necessary for the vehicle 12 to communicate with the communications equipment of the user 11, the facility can be simplified.

The vehicle 12 is an on-demand bus in the present embodiment but may be other types of on-demand vehicles such as a shared taxi. As the on-demand bus, an automobile of a given type such as a gasoline-powered car, a diesel car, an HV, a PHV, an EV, or an FCV can be used, for example. Here, “HV” is an abbreviation of Hybrid Vehicle. Further, “PHV” is an abbreviation of Plug-in Hybrid Vehicle. Further, “EV” is an abbreviation of Electric Vehicle. Further, “FCV” is an abbreviation of Fuel Cell Vehicle. The vehicle 12 is driven by a driver in the present embodiment, but its operation may be automated at a given level. The level of the automation is any level from level 1 to level 5 based on the classification of the SAE, for example. Here, “SAE” is an abbreviation of Society of Automotive Engineers. The vehicle 12 may be also a vehicle for exclusive use of MaaS. Here, “MaaS” is an abbreviation of Mobility as a Service.

The relationship between the user 11 and the vehicle 12 is not limited to a one-to-one relationship and may be a one-to-many relationship, a many-to-one relationship, or a many-to-many relationship. The user 11 may be an unspecified number of people. The vehicle 12 may be also used as a ride-sharing vehicle.

The operation support device 40 is communicable with the operation management device 30 via a network 13 such as a movable body communication network or the Internet.

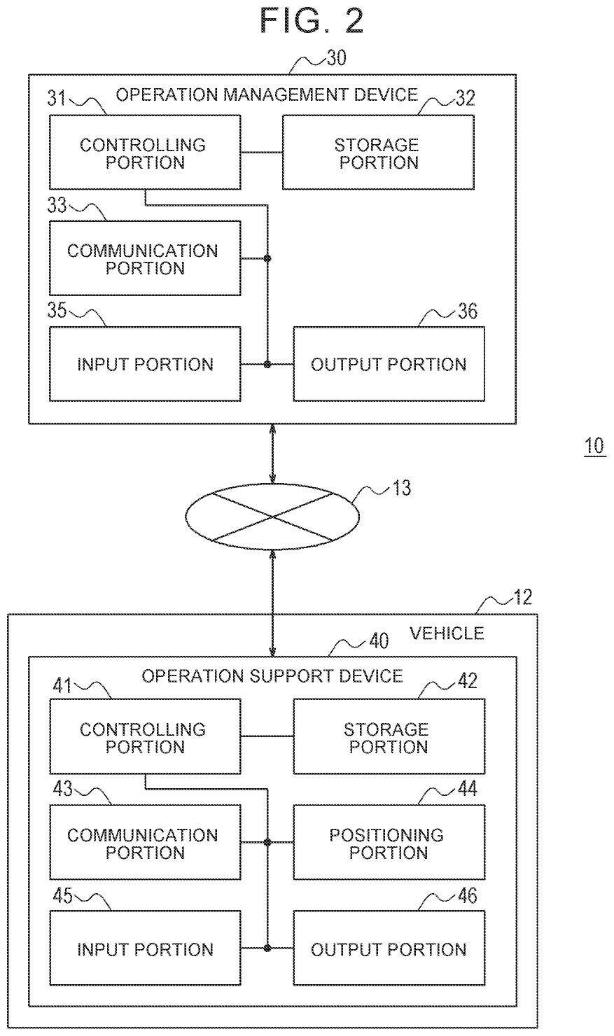

With reference to FIG. 2, the following describes the configuration of the on-demand traffic system 10 according to the present embodiment.

The on-demand traffic system 10 includes the operation management device 30 and the operation support device 40.

The operation management device 30 is a device configured to manage the operation of the vehicle 12. The operation management device 30 is provided in a given place such as a data center. The operation management device 30 is constituted as a server belonging to a cloud computing system or other computing systems.

The operation management device 30 includes constituents such as a controlling portion 31, a storage portion 32, a communication portion 33, an input portion 35, and an output portion 36.

The controlling portion 31 is constituted by one or more processors. As the processor, a general purpose processor such as a CPU or a dedicated processor devoted to a specific process can be used. Here, “CPU” is an abbreviation of Central Processing Unit. One or more dedicated communication circuits may be included in the controlling portion 31, or one or more processors may be replaced with one or more dedicated communication circuits in the controlling portion 31. As the dedicated communication circuit, an FPGA or an ASIC can be used, for example. Here, “FPGA” is an abbreviation of Field-Programmable Gate Array. Further, “ASIC” is an abbreviation of Application Specific Integrated Circuit. The controlling portion 31 executes information processing related to the operation of the operation management device 30 while the controlling portion 31 controls each part of the operation management device 30.

The storage portion 32 is constituted by one or more memories. As the memory, a semiconductor memory, a magnetic memory, or an optical memory can be used, for example. As the semiconductor memory, a RAM or a ROM can be used, for example. Here, “RAM” is an abbreviation of Random Access Memory. Further, “ROM” is an abbreviation of Read Only Memory. As the RAM, an SRAM or a DRAM can be used, for example. Here, “SRAM” is an abbreviation of Static Random Access Memory. Further, “DRAM” is an abbreviation of Dynamic Random Access Memory. As the ROM, an EEPROM can be used, for example. Here, “EEPROM” is an abbreviation of Electrically Erasable Programmable Read Only Memory. The memory functions as a main storage device, an auxiliary storage device, or a cache memory, for example. Information used for the operation of the operation management device 30 and information obtained by the operation of the operation management device 30 are stored in the storage portion 32.

The communication portion 33 is constituted by one or more data communication modules. As the data communication module, a data communication module corresponding to a LAN standard can be used, for example. Here, “LAN” is an abbreviation of Local Area Network. The communication portion 33 receives information used for the operation of the operation management device 30 via the network 13 and transmits information obtained by the operation of the operation management device 30 via the network 13.

The input portion 35 is constituted by one or more input interfaces. As the input interface, a physical key, an electrostatic capacitive key, a pointing device, a touchscreen provided integrally with a display, or a microphone can be used, for example. The input portion 35 receives an operation such as input, by the operator 14, of information used for the operation of the operation management device 30.

The output portion 36 is constituted by one or more output interfaces. As the output interface, a display or a speaker can be used, for example. As the display, an LCD or an organic EL display can be used, for example. Here, “LCD” is an abbreviation of Liquid Crystal Display. Further, “EL” is an abbreviation of Electro Luminescence. The output portion 36 outputs information obtained by the operation of the operation management device 30 to the operator 14.

The functions of the operation management device 30 are implemented by executing an operation management program of the present embodiment by a processor included in the controlling portion 31. That is, the functions of the operation management device 30 are implemented by software. The operation management program is a program for causing a computer to implement a function corresponding to a process of a step included in the operation of the operation management device 30 by causing the computer to execute the process of the step. That is, the operation management program is a program to functionalize the computer as the operation management device 30.

The program can be stored in a computer-readable recording medium. As the computer-readable recording medium, a magnetic recorder, an optical disc, a magneto-optical recording medium, or a semiconductor memory can be used, for example. The program is distributed by selling, transferring, or lending a portable recording medium such as a DVD or a CD-ROM in which the program is stored, for example. Here, “DVD” is an abbreviation of Digital Versatile Disc. Further, “CD-ROM” is an abbreviation of Compact Disc Read Only Memory. The program may be distributed by storing the program in a storage of a server and transferring the program to other computers from the server via the network 13. The program may be provided as a program product.

The computer temporarily stores, in the memory, the program stored in the portable recording medium or the program transferred from the server, for example. Then, the computer reads, by the processor, the program stored in the memory and executes, by the processor, a process in accordance with the program thus read. The computer may directly read the program from the portable recording medium and execute the process in accordance with the program. The computer may sequentially execute the process in accordance with the program every time the program is transferred to the computer from the server. The process may be executed by a so-called ASP service that implements the function only by an execution instruction and result acquisition without transferring the program from the server to the computer. Here, “ASP” is an abbreviation of Application Service Provider. The program includes a matter that is information used for processing by an electronic computer and is equivalent to the program. For example, data that is not a direct command to the computer but has a property defining the processing of the computer corresponds to “the matter equivalent to the program.”

Some of or all of the functions of the operation management device 30 may be implemented by a dedicated communication circuit included in the controlling portion 31. That is, some of or all of the functions of the operation management device 30 may be implemented by hardware.

The operation support device 40 is a device configured to support the operation of the vehicle 12. The operation support device 40 is provided in the vehicle 12. The operation support device 40 may be constituted as an in-vehicle device such as a fare display machine, a fare collection machine, or a navigation device, or the operation support device 40 may be constituted as an electronic device used by being connected to an in-vehicle device such as a mobile phone device, a smartphone, or a tablet.

The operation support device 40 includes constituents such as a controlling portion 41, a storage portion 42, a communication portion 43, a positioning portion 44, an input portion 45, and an output portion 46.

The controlling portion 41 is constituted by one or more processors. As the processor, a general purpose processor such as a CPU or a dedicated processor devoted to a specific process can be used. One or more dedicated communication circuits may be included in the controlling portion 41, or one or more processors may be replaced with one or more dedicated communication circuits in the controlling portion 41. As the dedicated communication circuit, an FPGA or an ASIC can be used, for example. One or more ECUs may be included in the controlling portion 41. Here, “ECU” is an abbreviation of Electronic Control Unit. The controlling portion 41 executes information processing related to the operation of the operation support device 40 while the controlling portion 41 controls each part of the vehicle 12 including the operation support device 40.

The storage portion 42 is constituted by one or more memories. As the memory, a semiconductor memory, a magnetic memory, or an optical memory can be used, for example. As the semiconductor memory, a RAM or a ROM can be used, for example. As the RAM, an SRAM or a DRAM can be used, for example. As the ROM, an EEPROM can be used, for example. The memory functions as a main storage device, an auxiliary storage device, or a cache memory, for example. Information used for the operation of the operation support device 40 and information obtained by the operation of the operation support device 40 are stored in the storage portion 42.

The communication portion 43 is constituted by one or more data communication modules. As the data communication module, a data communication module corresponding to LTE, 4G, or 5G can be used, for example. Here, “LTE” is an abbreviation of Long Term Evolution. Further, “4G” is an abbreviation of 4th Generation. Further, “5G” is an abbreviation of 5th Generation. The communication portion 43 receives information used for the operation of the operation support device 40 and transmits information obtained by the operation of the operation support device 40.

The positioning portion 44 is constituted by one or more positioning modules. As the positioning module, a positioning module corresponding to a GNSS can be used, for example. Here, “GNSS” is an abbreviation of Global Navigation Satellite System. The GNSS includes at least one of a GPS, a QZSS, a GLONASS, and Galileo, for example. Here, “GPS” is an abbreviation of Global Positioning System. Further, “QZSS” is an abbreviation of Quasi-Zenith Satellite System. A satellite of the QZSS is referred to as a quasi-zenith satellite. Further, “GLONASS” is an abbreviation of Global Navigation Satellite System. The positioning portion 44 acquires position information of the vehicle 12.

The input portion 45 is constituted by one or more input interfaces. As the input interface, a physical key, an electrostatic capacitive key, a pointing device, a touchscreen provided integrally with an in-vehicle display, or an in-vehicle microphone can be used, for example. The input portion 45 receives an operation such as input, by a driver of the vehicle 12 or a person who boards the vehicle 12, of information used for the operation of the operation support device 40.

The output portion 46 is constituted by one or more output interfaces. As the output interface, an in-vehicle display or an in-vehicle speaker can be used, for example. As the in-vehicle display, an HUD, an LCD, or an organic EL display can be used, for example. Here, “HUD” is an abbreviation of Head-Up Display. The output portion 46 outputs information obtained by the operation of the operation support device 40 to the driver of the vehicle 12 or the person who boards the vehicle 12.

The functions of the operation support device 40 are implemented by executing an operation support program of the present embodiment by a processor included in the controlling portion 41. That is, the functions of the operation support device 40 are implemented by software. The operation support program is a program for causing a computer to implement a function corresponding to a process of a step included in the operation of the operation support device 40 by causing the computer to execute the process of the step. That is, the operation support program is a program to functionalize the computer as the operation support device 40.

Some of or all of the functions of the operation support device 40 may be implemented by a dedicated communication circuit included in the controlling portion 41. That is, some of or all of the functions of the operation support device 40 may be implemented by hardware.

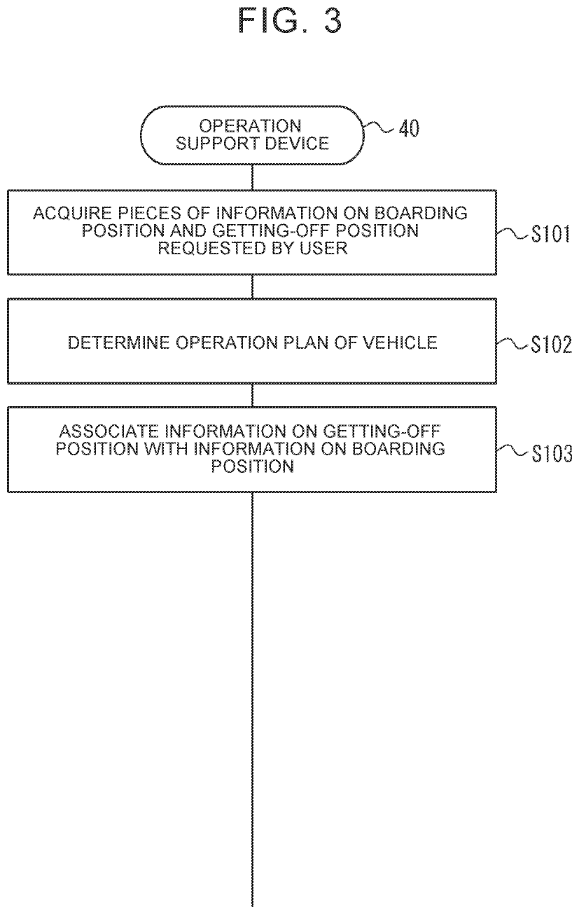

With reference to FIGS. 3 to 6, the following describes the operation of the on-demand traffic system 10 according to the present embodiment.

FIG. 3 illustrates the operation of the on-demand traffic system 10 at the time when the user 11 makes a reservation for the vehicle 12. This operation corresponds to a reservation support method according to the present embodiment.

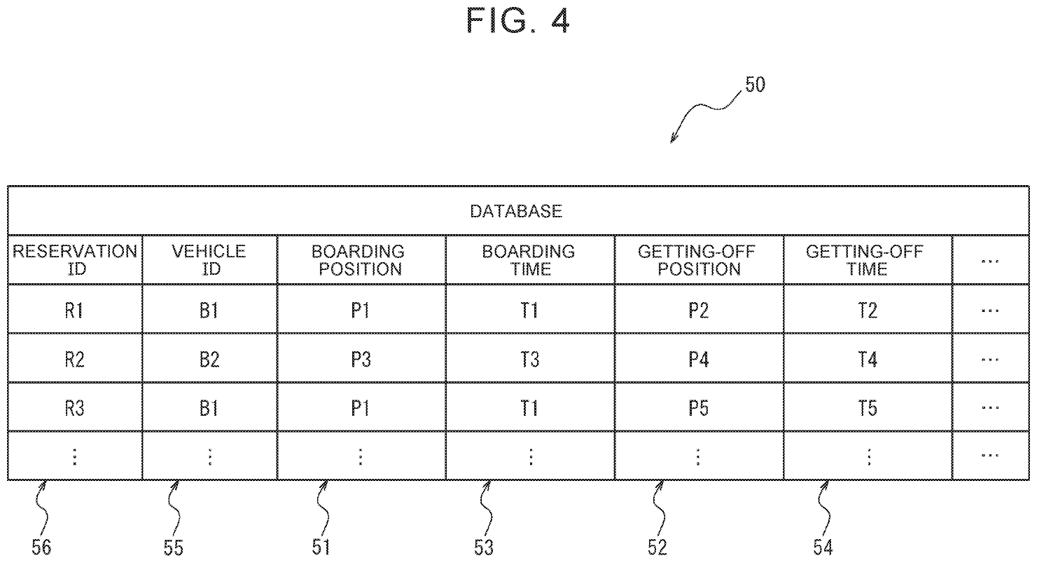

FIG. 4 illustrates an example of a database 50 to be accessed in the operation of FIG. 3.

Processes from step S101 to step S103 are executed by the operation management device 30.

In step S101, the controlling portion 31 acquires pieces of information on a boarding position and a getting-off position requested by the user 11. In the present embodiment, the controlling portion 31 also acquires pieces of information on a boarding time and a getting-off time requested by the user 11.

More specifically, the controlling portion 31 receives operations by the operator 14 to input boarding position information 51, getting-off position information 52, boarding time information 53, and getting-off time information 54 through the input portion 35. Alternatively, the controlling portion 31 receives, through the communication portion 33, the boarding position information 51, the getting-off position information 52, the boarding time information 53, and the getting-off time information 54 from a terminal device such as a PC of the operator 14. The boarding position information 51 is information on a boarding position P1 requested by the user 11, the information being notified from the user 11 to the operator 14 by telephone or e-mail. The getting-off position information 52 is information on a getting-off position P2 requested by the user 11, the information being notified from the user 11 to the operator 14 by telephone or e-mail. The boarding position P1 and the getting-off position P2 are expressed in a given form such as a place name, an address, or a point or a region on a map. The boarding time information 53 is information on a boarding time T1 requested by the user 11, the information being notified from the user 11 to the operator 14 by telephone or e-mail. The getting-off time information 54 is information on a getting-off time T2 requested by the user 11, the information being notified from the user 11 to the operator 14 by telephone or e-mail. The boarding time T1 and the getting-off time T2 are expressed in a given form such as date and time or a date and a time slot. The controlling portion 31 stores, in the storage portion 32, the boarding position information 51, the getting-off position information 52, the boarding time information 53, and the getting-off time information 54 thus input or received.

In step S102, the controlling portion 31 determines an operation plan of the vehicle 12 in accordance with the pieces of information on the boarding position and the getting-off position that are acquired in step S101. In the present embodiment, the controlling portion 31 determines the operation plan of the vehicle 12 in accordance with the pieces of information on the boarding position and the getting-off position and the pieces of information on the boarding time and the getting-off time that are acquired in step S101.

More specifically, the controlling portion 31 arranges the vehicle 12 in accordance with the request of the user 11 that is designated by the boarding position information 51, the getting-off position information 52, the boarding time information 53, and the getting-off time information 54 that are stored in the storage portion 32 and determines the operation plan such as a travel route and an operation schedule for the vehicle 12 thus arranged. The controlling portion 31 stores a vehicle ID 55 of the arranged vehicle 12 in the storage portion 32 as identification information of the vehicle 12. The vehicle ID 55 is a given value or text.

Here, the controlling portion 31 selects, from among a plurality of candidate on-demand buses, a bus B1 that can arrive at the boarding position P1 by the boarding time T1 and reach the getting-off position P2 by the getting-off time T2. The controlling portion 31 determines an operation plan of the bus B1 so that the bus B1 can arrive at the boarding position P1 by the boarding time T1 and reach the getting-off position P2 by the getting-off time T2.

In step S103, the controlling portion 31 associates the information on the getting-off position that is acquired in step S101 with the information on the boarding position that is acquired in step S101.

More specifically, the controlling portion 31 issues a new reservation ID 56 as identification information of the reservation. As illustrated in FIG. 4, the controlling portion 31 registers the reservation ID 56 thus issued in the storage portion 32 or the database 50 constructed in an external storage as a main key and also registers, in the database 50 in association with the reservation ID 56, the vehicle ID 55, the boarding position information 51, the getting-off position information 52, the boarding time information 53, and the getting-off time information 54 that are stored in the storage portion 32. The reservation ID 56 is a given value or text.

The reservation ID 56 issued herein is identification information of a reservation R1 made by the user 11. In a case where there is another reservation R2 made by the same user 11, the controlling portion 31 issues another reservation ID 56 as identification information of the reservation R2 as illustrated in the example of FIG. 4. In this example, since it is not necessary to authenticate the user 11 at the time of making a reservation, it is possible to simplify the procedure of the process.

As one modification of the present embodiment, the operation plan of the vehicle 12 may be determined manually by the operator 14. In this case, in step S102, the controlling portion 31 of the operation management device 30 outputs, to the operator 14 through the output portion 36, the boarding position information 51, the getting-off position information 52, the boarding time information 53, and the getting-off time information 54.

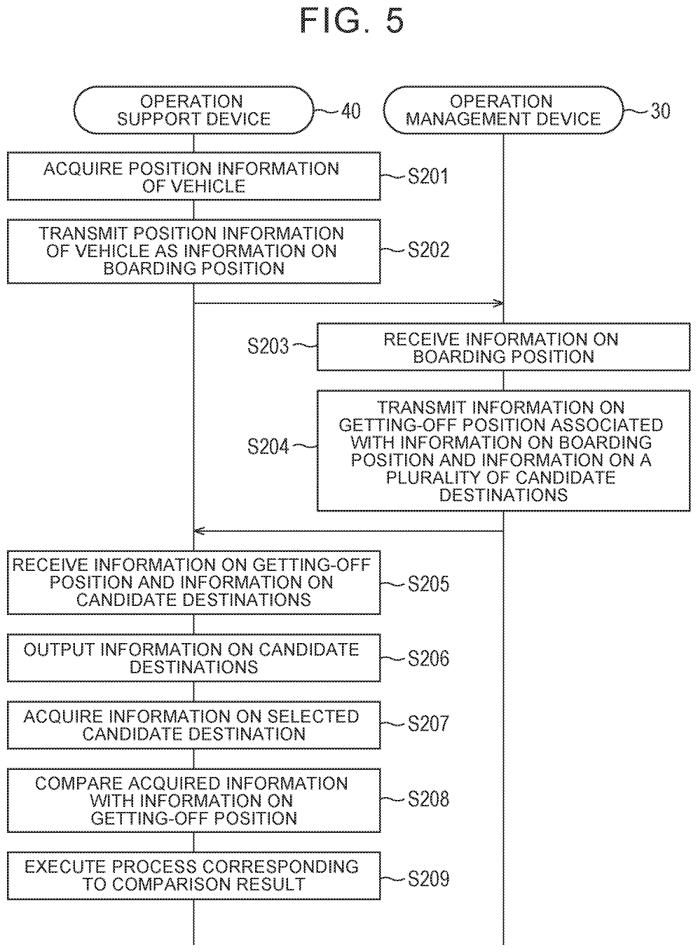

FIG. 5 illustrates the operation of the on-demand traffic system 10 at the time when the user 11 boards the vehicle 12. This operation corresponds to an operation support method according to the present embodiment.

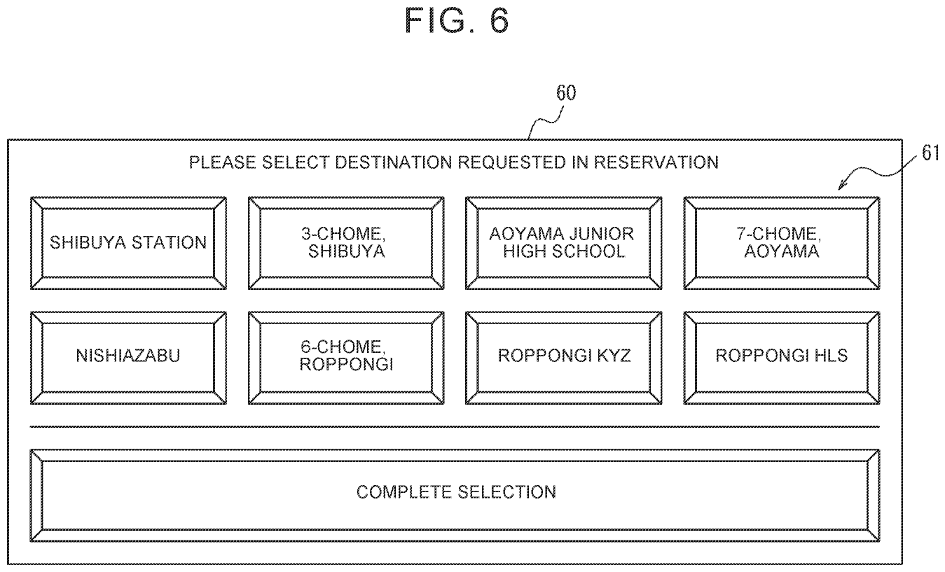

FIG. 6 illustrates an example of a selection screen 60 output in the operation of FIG. 5.

Processes of step S201 and step S202 are executed by the operation support device 40 of the vehicle 12 stopping at the boarding position.

In step S201, the controlling portion 41 acquires position information of the vehicle 12 through the positioning portion 44.

More specifically, the controlling portion 41 determines whether the vehicle 12 is stopping or not, by use of a positioning module included in the positioning portion 44 or a sensor such as an acceleration sensor or a gyroscope provided in the vehicle 12. The controlling portion 41 determines whether a person is boarding the vehicle 12 or not, by use of a camera or a motion sensor provided in the vehicle 12 or an opening-closing sensor provided in a door of the vehicle 12. When the controlling portion 41 determines that the vehicle 12 is stopping and the person is boarding the vehicle 12, the controlling portion 41 acquires two-dimensional coordinates or three-dimensional coordinates of a current position of the vehicle 12 as the position information of the vehicle 12 through the positioning portion 44. The controlling portion 41 stores the two-dimensional coordinates or three-dimensional coordinates thus acquired in the storage portion 42.

In step S202, the controlling portion 41 transmits the position information of the vehicle 12 that is acquired in step S201 to the operation management device 30 through the communication portion 43.

More specifically, the controlling portion 41 transmits the two-dimensional coordinates or three-dimensional coordinates stored in the storage portion 42 and the vehicle ID 55 stored in the storage portion 42 in advance to the operation management device 30 through the communication portion 43.

Processes of step S203 and step S204 are executed by the operation management device 30.

In step S203, the controlling portion 31 receives the position information of the vehicle 12 that is transmitted in step S202, from the operation support device 40 of the vehicle 12 through the communication portion 33.

More specifically, the controlling portion 31 receives the two-dimensional coordinates or three-dimensional coordinates of the current position of the vehicle 12 and the vehicle ID 55 from the operation support device 40 of the vehicle 12 via the network 13 through the communication portion 33. The controlling portion 31 stores the two-dimensional coordinates or three-dimensional coordinates and the vehicle ID 55 thus received in the storage portion 32.

In step S204, in response to the position information of the vehicle 12 that is received in step S203, the controlling portion 31 transmits, through the communication portion 33, the information on the getting-off position that is associated with the boarding position information 51 corresponding to the position information of the vehicle 12 in step S103 and information on a plurality of candidate destinations including information on a candidate destination corresponding to the getting-off position. In the present embodiment, the controlling portion 31 includes, in the information on the candidate destinations to be transmitted, information on a dummy candidate that does not correspond to the getting-off position of the user 11. In a case where there is a plurality of reservations having the same boarding position and different getting-off positions, the controlling portion 31 includes, in the information on the candidate destinations to be transmitted, information on a candidate destination that does not correspond to any of the getting-off positions of the reservations as the information on the dummy candidate.

More specifically, the controlling portion 31 searches the database 50 by use of, as a search key, a pair of the boarding position information 51 stored in the storage portion 32 and corresponding to the two-dimensional coordinates or three-dimensional coordinates of the current position of the vehicle 12 and the vehicle ID 55 stored in the storage portion 32. The controlling portion 31 generates candidate destination information 61 indicative of a name of a candidate destination corresponding to the getting-off position indicated by the getting-off position information 52 provided as a search result from the database 50 and a name of a dummy candidate that does not correspond to the getting-off position. The controlling portion 31 transmits the acquired getting-off position information 52 and the generated candidate destination information 61 to the operation support device 40 of the vehicle 12 via the network 13 through the communication portion 33.

Herein, when a current position of the bus B1 is the same as the boarding position P1 or a difference between those positions is a threshold or less, information indicative of a name of the getting-off position P2 is obtained as a search result. The getting-off position P2 is assumed as “Roppongi HLS.” In terms of the bus B1, there is a reservation R2 in which the same boarding position P1 as that of the reservation R1 and a getting-off position P5 different from that of the reservation R1 are requested, and the getting-off position P5 is assumed as “Nishiazabu.” It is assumed that a route where the bus B1 can travel includes “Shibuya Station,” “3-Chome, Shibuya,” “Aoyama Junior High School,” “7-Chome, Aoyama,” “6-Chome, Roppongi,” and “Roppongi KYZ.” In this case, the controlling portion 31 generates, as the candidate destination information 61, information indicative of names of eight candidate destinations, i.e., the candidate destination “Roppongi HLS” corresponding to the getting-off position P2, the candidate destination “Nishiazabu” corresponding to the getting-off position P5, and dummy candidates “Shibuya Station,” “3-Chome, Shibuya,” “Aoyama Junior High School,” “7-Chome, Aoyama,” “6-Chome, Roppongi,” and “Roppongi KYZ.”

As another example, the getting-off position information 52 may be also information indicative of an address of the getting-off position, instead of the name of the getting-off position. The candidate destination information 61 may be also information indicative of addresses of the candidate destinations, instead of the names of the candidate destinations.

Processes from step S205 to step S209 are executed by the operation support device 40 of the vehicle 12.

In step S205, the controlling portion 41 receives the information on the getting-off position and the information on the candidate destinations that are transmitted in step S204, from the operation management device 30 through the communication portion 43.

More specifically, the controlling portion 41 receives the getting-off position information 52 and the candidate destination information 61 from the operation management device 30 through the communication portion 43. The controlling portion 41 stores the getting-off position information 52 and the candidate destination information 61 thus received in the storage portion 42.

In step S206, the controlling portion 41 outputs the information on the candidate destinations that is received in step S205 through the output portion 46.

More specifically, as illustrated in FIG. 6, the controlling portion 41 outputs, to an in-vehicle display included in the output portion 46, the selection screen 60 on which the names of the eight candidate destinations indicated by the candidate destination information 61 stored in the storage portion 42 are displayed in parallel with respect to the person boarding the vehicle 12.

In step S207, the controlling portion 41 receives an operation by the person boarding the vehicle 12 to select one candidate destination from the information on the candidate destinations that is output in step S206 through the input portion 45. The controlling portion 41 acquires information on the candidate destination thus selected.

More specifically, the controlling portion 41 acquires information indicative of the name of the candidate destination selected by the person boarding the vehicle 12, on a touchscreen included in the input portion 45, from among the names of the eight candidate destinations displayed on the selection screen 60 output to the in-vehicle display. The controlling portion 41 stores the information thus acquired in the storage portion 42.

In step S208, the controlling portion 41 compares the information on the candidate destination that is acquired in step S207 with the information on the getting-off position that is received in step S205.

More specifically, the controlling portion 41 compares the information indicative of the name of the candidate destination selected by the person boarding the vehicle 12, the information being stored in the storage portion 42, with the getting-off position information 52 stored in the storage portion 42.

In step S209, the controlling portion 41 executes a process corresponding to a comparison result in step S208. In the present embodiment, when the candidate destination indicated by the information acquired in step S207 matches the getting-off position indicated by the information received in step S205, the controlling portion 41 notifies the driver of the vehicle 12 that the user 11 who has made the reservation has boarded the vehicle 12. In the meantime, when the candidate destination indicated by the information acquired in step S207 does not match the getting-off position indicated by the information received in step S205, the controlling portion 41 notifies the driver of the vehicle 12 that a person different from the user 11 who has made the reservation has boarded the vehicle 12.

More specifically, when the name of the candidate destination selected by the person boarding the vehicle 12, the name being indicated by the information stored in the storage portion 42, matches the name of the getting-off position indicated by the getting-off position information 52 stored in the storage portion 42, the controlling portion 41 outputs, to the driver of the vehicle 12 through the output portion 46, a message indicating that the user 11 who has made the reservation has boarded the vehicle 12. In the meantime, when the name of the candidate destination selected by the person boarding the vehicle 12, the name being indicated by the information stored in the storage portion 42, does not match the name of the getting-off position indicated by the getting-off position information 52 stored in the storage portion 42, the controlling portion 41 outputs, to the driver of the vehicle 12 through the output portion 46, a message indicating that a person different from the user 11 who has made the reservation has boarded the vehicle 12.

In the example of FIG. 6, the getting-off position information 52 is information indicative of “Roppongi HLS” and “Nishiazabu” as respective names of the getting-off position P2 and the getting-off position P5. Accordingly, when the name of the candidate destination selected by the person boarding the vehicle 12 is either “Roppongi HLS” or “Nishiazabu,” the driver of the vehicle 12 is notified that the person is the user 11 who has made the reservation. In the meantime, when the name of the candidate destination selected by the person boarding the vehicle 12 is any of “Shibuya Station,” “3-Chome, Shibuya,” “Aoyama Junior High School,” “7-Chome, Aoyama,” “6-Chome, Roppongi,” and “Roppongi KYZ,” the driver of the vehicle 12 is notified that the person is not the user 11 who has made the reservation.

As one modification of the present embodiment, the candidate destination information 61 may include information on a simplified name or address of the getting-off position as the information on the candidate destination corresponding to the getting-off position indicated by the getting-off position information 52.

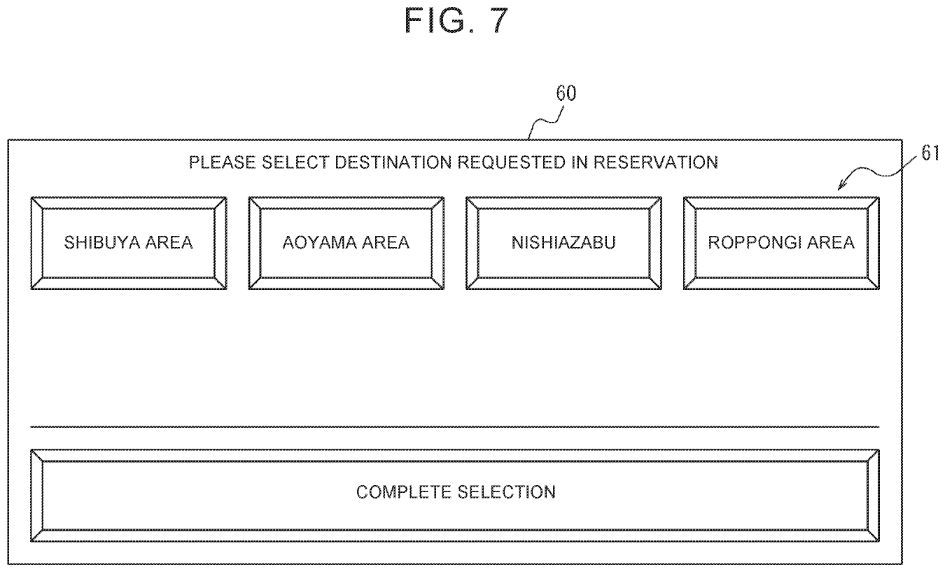

FIG. 7 illustrates an example of the selection screen 60 output in the modification.

In the example of FIG. 7, the candidate destination information 61 is information indicative of names of four candidate destinations, i.e., a candidate destination “Roppongi area” as a simplified name of the getting-off position P2, the candidate destination “Nishiazabu” corresponding to the getting-off position P5, and dummy candidates “Shibuya area” and “Aoyama area.” In this example, the controlling portion 31 of the operation management device 30 adjusts the simplification level and further selects the dummy candidates appropriately so that the candidate destinations do not overlap with each other in the candidate destination information 61. Further, in a case where there is a plurality of reservations having the same boarding position and different getting-off positions, the controlling portion 31 adjusts the simplification level so that the candidate destinations do not overlap with each other among the reservations. For example, “Aoyama area,” “Nishiazabu,” and “Roppongi area” all exist in “Minato-ku,” Tokyo. Accordingly, the controlling portion 31 sets the candidate destination corresponding to the getting-off position P2 to “Roppongi area” without simplifying “Roppongi HLS” to “Minato-ku” so that the candidate destination corresponding to the getting-off position P2 does not overlap with the dummy candidate “Aoyama area” and also does not overlap with the getting-off position P5. If the getting-off position P5 is “6-Chome, Roppongi” instead of “Nishiazabu,” the controlling portion 31 sets the candidate destination corresponding to the getting-off position P2 to “Roppongi HLS” as it is without simplifying “Roppongi HLS” to “Roppongi area” so that the candidate destination corresponding to the getting-off position P2 does not overlap with the getting-off position P5.

As one modification of the present embodiment, the controlling portion 41 of the operation support device 40 may compare the number of people who have boarded the vehicle 12 at the boarding position with the number of people who have made reservations having the same boarding position and may notify the driver of the vehicle 12 of a comparison result. In this case, in step S204, the controlling portion 31 of the operation management device 30 transmits information indicative of the number of hits in the database 50 as information indicative of the number of people making the reservations with the same boarding position, together with the getting-off position information 52 and the candidate destination information 61. In step S205, the controlling portion 41 of the operation support device 40 receives those pieces of information. In step S209, the controlling portion 41 compares the number of people making the reservations with the same boarding position, indicated by the information received in step S205, with the number of times by which the candidate destination indicated by the information acquired in step S207 matches the getting-off position indicated by the information received in step S205 during the stop of the vehicle 12. Until the latter number reaches the former number, the controlling portion 41 outputs, to the driver of the vehicle 12, a message indicating that not all the users 11 making the reservations have boarded the vehicle 12, and the controlling portion 41 repeats the processes from step S206 to step S209. When the latter number reaches the former number, the controlling portion 41 outputs, to the driver of the vehicle 12, a message indicating that all the users 11 making the reservations have boarded the vehicle 12.

As one modification of the present embodiment, the controlling portion 31 of the operation management device 30 may not include, in the information on the candidate destinations to be transmitted, the information on the dummy candidates. In this case, in a case where there is a plurality of reservations having the same boarding position and different getting-off positions, the controlling portion 31 includes, in the information on the candidate destinations to be transmitted, only information on candidate destinations corresponding to respective getting-off positions of the reservations.

As described above, in the present embodiment, the operation support device 40 supports the operation of the vehicle 12 for which the operation plan is determined in accordance with the boarding position and the getting-off position requested by the reservation. When one candidate destination is selected by a person who boards the vehicle 12 at the boarding position from information on a plurality of candidate destinations that is output in the vehicle 12 stopping at the boarding position, the controlling portion 41 of the operation support device 40 acquires information on the candidate destination thus selected. The controlling portion 41 compares the information thus acquired with information on the getting-off position that is associated with information on the boarding position at the time of making the reservation. Thus, in the present embodiment, when a person boards the vehicle 12, the candidate destination selected by the person is compared with the getting-off position associated with the boarding position corresponding to the position of the vehicle 12. Hereby, it is possible to check whether the person is the user 11 who has made the reservation or not, regardless of whether the person carries communications equipment such as a wireless tag or not.

In the present embodiment, the controlling portion 31 of the operation management device 30 receives, through the communication portion 33, the position information of the vehicle 12 for which the operation plan is determined in accordance with the boarding position and the getting-off position requested by the reservation, the position information of the vehicle 12 being transmitted from the vehicle 12 during stop at the boarding position. In response to the position information of the vehicle 12, the controlling portion 31 transmits, through the communication portion 33, the information on the getting-off position associated with the information on the boarding position corresponding to the position information of the vehicle 12 at the time of making the reservation and the information on the candidate destinations including the information on the candidate destination corresponding to the getting-off position. Accordingly, in the present embodiment, when a person boards the vehicle 12, the vehicle 12 can acquire the information on the candidate destinations from which the person can correctly select the getting-off position only when the person is the user 11 who has made the reservation, in exchange for the information on the boarding position.

As one modification of the present embodiment, the database 50 may be constructed in the storage portion 42 of the operation support device 40. In this case, in step S103, the reservation ID 56, the vehicle ID 55, the boarding position information 51, the getting-off position information 52, the boarding time information 53, and the getting-off time information 54 are registered in the database 50 of the operation support device 40 of the vehicle 12 arranged in step S102. The processes from step S202 to step S205 are omitted. Similarly to the process in step S204, the controlling portion 41 of the operation support device 40 searches the database 50 by use of, as a search key, a pair of the boarding position information 51 corresponding to the two-dimensional coordinates or three-dimensional coordinates of the current position of the vehicle 12 and the vehicle ID 55 and also generates the candidate destination information 61, so that the controlling portion 41 acquires information necessary for the processes from step S206 to step S208.

As one modification of the present embodiment, the operation support device 40 may be constituted as a server belonging to a cloud computing system or other computing systems. The operation support device 40 may be integrated with the operation management device 30. In this case, the processes of step S201, step S202, step S205, step S206, and step S209 are executed by the vehicle 12. The process of step S208 is executed by the server. In step S204 and step S205, out of the information on the getting-off position and the information on the candidate destinations, only the information on the candidate destinations is transmitted to the vehicle 12 from the server. In step S207, information on the selected candidate destination is uploaded to the server from the vehicle 12. In step S208, a comparison result is transmitted to the vehicle 12 from the server.

As one modification of the present embodiment, the information on the candidate destinations may not be output in the vehicle 12 stopping at the boarding position, and a given candidate destination may be input by a person who boards the vehicle 12 at the boarding position instead. In this case, when one candidate destination is input by the person who boards the vehicle 12 at the boarding position in the vehicle 12 stopping at the boarding position, the controlling portion 41 of the operation support device 40 acquires information on the candidate destination thus input. The controlling portion 41 compares the information thus acquired with the information on the getting-off position that is associated with the information on the boarding position at the time of making the reservation. For the operation to input one candidate destination by the person who boards the vehicle 12, a physical key, an electrostatic capacitive key, a pointing device, a touchscreen, or an in-vehicle microphone included in the input portion 45 can be used, for example.

### Second Embodiment

With reference to FIG. 1, the outline of the present embodiment will be described below. Descriptions are omitted or simplified appropriately in terms of parts common to the first embodiment.

In the on-demand traffic system 10 according to the present embodiment, an attribute of the user 11 planned to board the vehicle 12 is designated at the time of making a reservation. The vehicle 12 outputs information on a plurality of candidate attributes in addition to the information on the candidate destinations, while the vehicle 12 is stopping at the boarding position. The operation management device 30 transmits, to the operation support device 40 at a given point of time, pieces of information on the getting-off position and the attribute that are associated with information on the boarding position at the time of making the reservation. When one candidate destination and one candidate attribute are selected by a person who boards the vehicle 12 at the boarding position from among the pieces of information output in the vehicle 12, the operation support device 40 acquires pieces of information on the selected candidate destination and the selected candidate attribute. The operation support device 40 compares the pieces of information thus acquired with the pieces of information on the getting-off position and the attribute that are associated with the information on the boarding position at the time of making the reservation.

With the present embodiment, when a person boards the vehicle 12, it is possible to more accurately check whether the person is the user 11 who has made the reservation or not, regardless of whether the person carries communications equipment such as a wireless tag or not.

In the present embodiment, the person who boards the vehicle 12 is requested to show, as secret information, information such as a name of the person that the person never forgets, instead of being requested to show information such as a reservation number or a passcode that the person might forget. In the present embodiment, it is not necessary for the user 11 to remember the information that the user 11 might forget, so that the convenience improves. Since the operator 14 does not need to notify the user 11 of a reservation number or ask the user 11 about a passcode at the time when the user 11 makes the reservation, the service can be made more efficient.

The configuration of the on-demand traffic system 10 according to the present embodiment is the same as the one described in the first embodiment as illustrated in FIG. 2, so that its description is omitted.

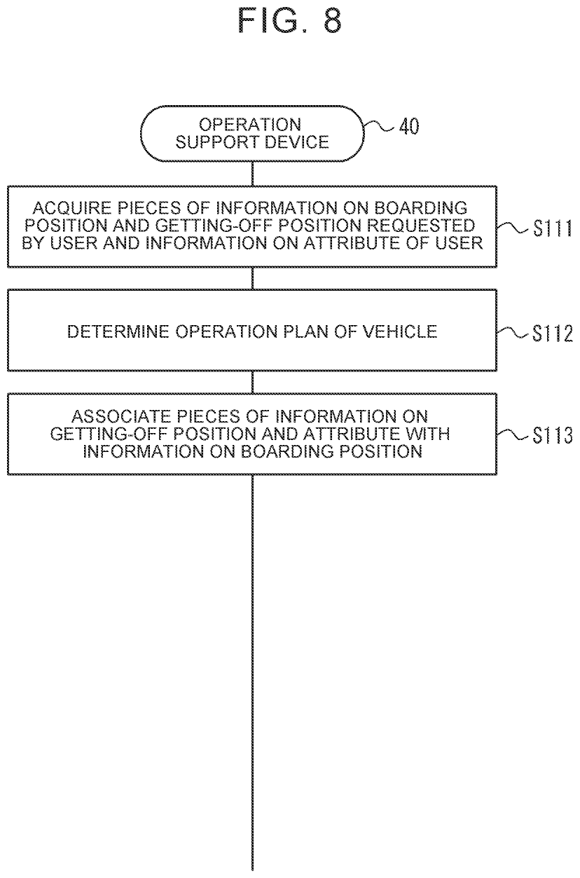

With reference to FIGS. 8 to 11, the following describes the operation of the on-demand traffic system 10 according to the present embodiment. Descriptions are omitted or simplified appropriately in terms of parts common to the first embodiment.

FIG. 8 illustrates the operation of the on-demand traffic system 10 at the time when the user 11 makes a reservation for the vehicle 12. This operation corresponds to a reservation support method according to the present embodiment.

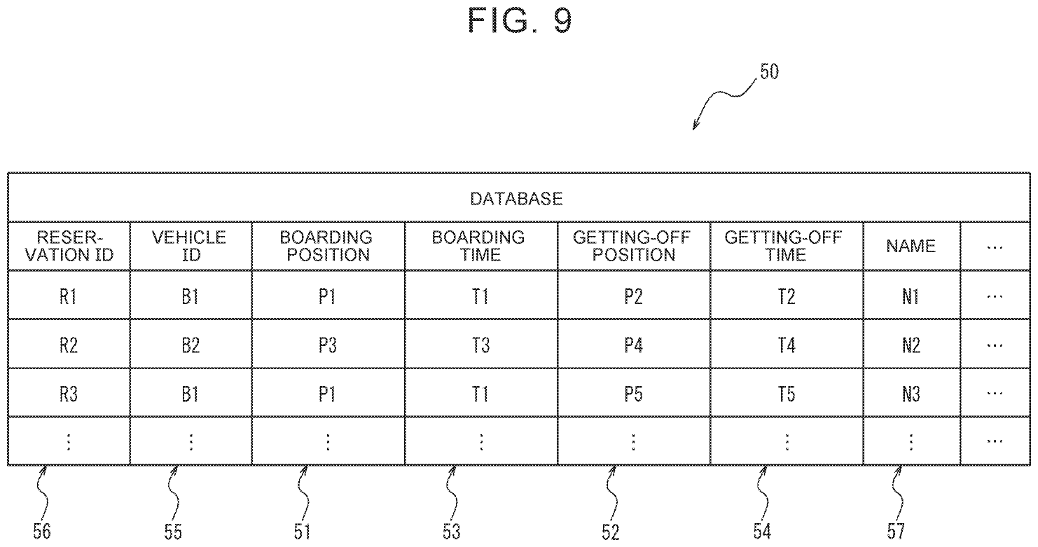

FIG. 9 illustrates an example of the database 50 to be accessed in the operation of FIG. 8.

Processes from step S111 to step S113 are executed by the operation management device 30.

In step S111, the controlling portion 31 acquires pieces of information on the boarding position and the getting-off position requested by the user 11 and information on the attribute of the user 11.

More specifically, the controlling portion 31 receives operations by the operator 14 to input the boarding position information 51, the getting-off position information 52, the boarding time information 53, the getting-off time information 54, and attribute information 57 through the input portion 35. Alternatively, the controlling portion 31 receives, through the communication portion 33, the boarding position information 51, the getting-off position information 52, the boarding time information 53, the getting-off time information 54, and the attribute information 57 from a terminal device such as a PC of the operator 14. The attribute information 57 is information on an attribute such as a name N1 of the user 11, the information being notified from the user 11 to the operator 14 by telephone or e-mail. The controlling portion 31 stores, in the storage portion 32, the boarding position information 51, the getting-off position information 52, the boarding time information 53, the getting-off time information 54, and the attribute information 57 thus input or received.

Since a process of step S112 is the same as the process of step S102, its description is omitted.

In step S113, the controlling portion 31 associates the pieces of information on the getting-off position and the attribute that are acquired in step S111 with the information on the boarding position that is acquired in step S111.

More specifically, the controlling portion 31 issues a new reservation ID 56 as identification information of the reservation. As illustrated in FIG. 9, the controlling portion 31 registers the reservation ID 56 thus issued in the database 50 as a main key and registers, in the database 50 in association with the reservation ID 56, the vehicle ID 55, the boarding position information 51, the getting-off position information 52, the boarding time information 53, the getting-off time information 54, and the attribute information 57 that are stored in the storage portion 32.

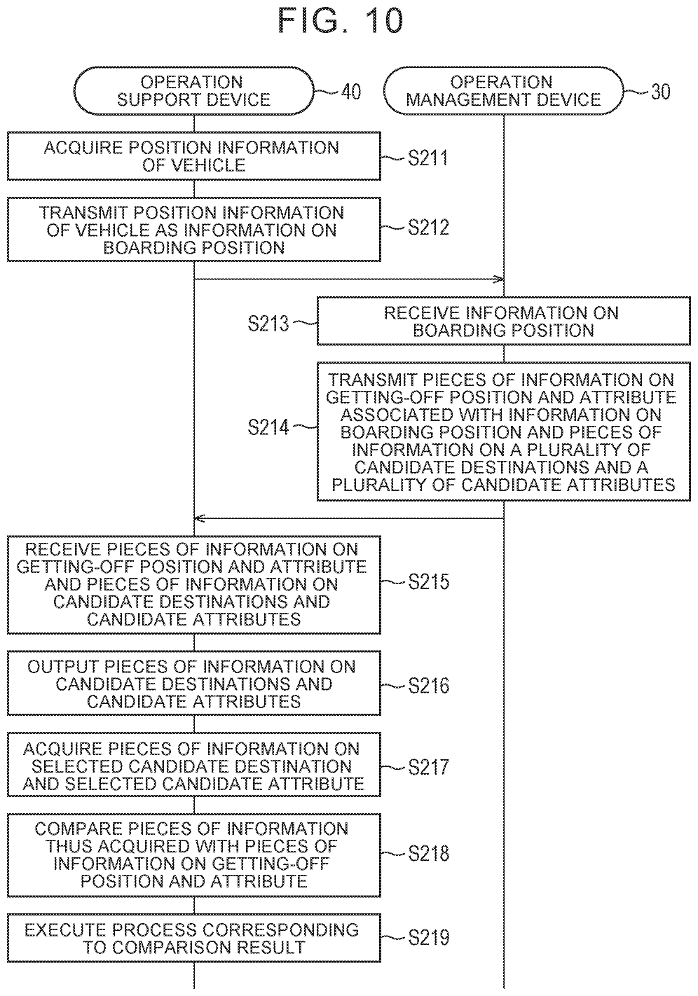

FIG. 10 illustrates the operation of the on-demand traffic system 10 at the time when the user 11 boards the vehicle 12. This operation corresponds to an operation support method according to the present embodiment.

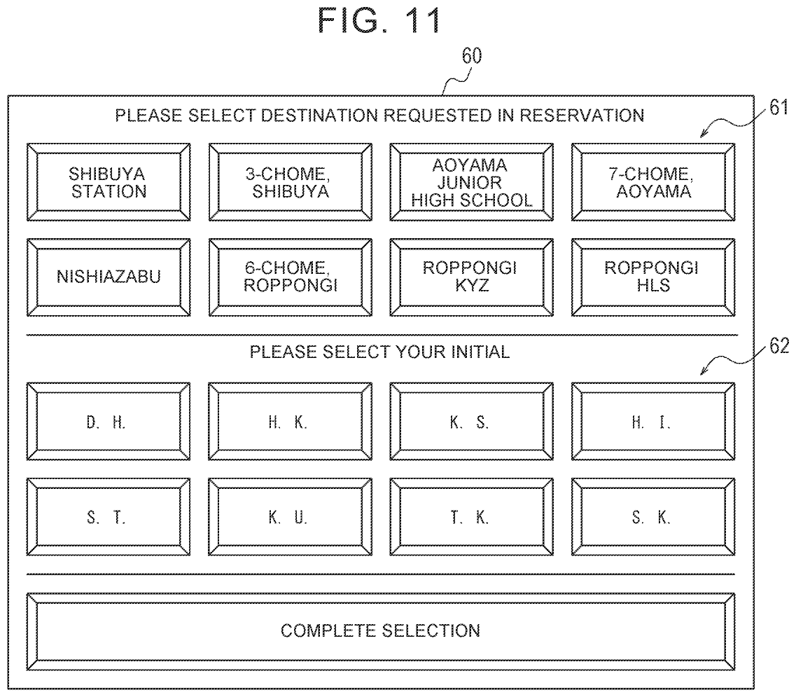

FIG. 11 illustrates an example of the selection screen 60 output in the operation of FIG. 10.

Processes of step S211 and step S212 are executed by the operation support device 40 of the vehicle 12 stopping at the boarding position.

Since the processes of step S211 and step S212 are the same as the processes of step S201 and S202, their descriptions are omitted.

Processes of step S213 and step S214 are executed by the operation management device 30.

Since the process of step S213 is the same as the process of step S203, its description is omitted.

In step S214, in response to position information of the vehicle 12 that is received in step S213, the controlling portion 31 transmits, through the communication portion 33, the pieces of information on the getting-off position and the attribute that are associated with the boarding position information 51 corresponding to the position information of the vehicle 12 in step S113, information on a plurality of candidate destinations including information on a candidate destination corresponding to the getting-off position, and information on a plurality of candidate attributes including information on a candidate attribute corresponding to the attribute. In the present embodiment, the controlling portion 31 includes, in the information on the candidate attributes to be transmitted, information on a dummy candidate that does not correspond to the attribute of the user 11. In a case where there is a plurality of reservations having the same boarding position and different attributes, the controlling portion 31 includes, in the information on the candidate attributes to be transmitted, information on a candidate attribute that does not correspond to any of the attributes of the reservations as the information on the dummy candidate.

More specifically, the controlling portion 31 searches the database 50 by use of, as a search key, a pair of the boarding position information 51 stored in the storage portion 32 and corresponding to the two-dimensional coordinates or three-dimensional coordinates of the current position of the vehicle 12 and the vehicle ID 55 stored in the storage portion 32. The controlling portion 31 generates the candidate destination information 61 indicative of a name of a candidate destination corresponding to the getting-off position indicated by the getting-off position information 52 provided as a search result from the database 50 and a name of a dummy candidate that does not correspond to the getting-off position. The controlling portion 31 generates candidate attribute information 62 indicative of a candidate attribute corresponding to the attribute indicated by the attribute information 57 provided as the search result from the database 50 and a dummy candidate that does not correspond to the attribute. The controlling portion 31 transmits the acquired getting-off position information 52, the acquired attribute information 57, the generated candidate destination information 61, and the generated candidate attribute information 62 to the operation support device 40 of the vehicle 12 via the network 13 through the communication portion 33.

In the present embodiment, the information on the candidate attributes to be transmitted from the controlling portion 31 includes information on a simplified name of the user 11 as the information on the candidate attribute corresponding to the attribute of the user 11. That is, the controlling portion 31 generates the information on the candidate attribute corresponding to the attribute of the user 11 by simplifying the name of the user 11.

More specifically, the controlling portion 31 generates information indicative of eight candidate attributes, i.e., a candidate attribute “H.K.” obtained by converting the name N1 into an initial, a candidate attribute “S.K.” obtained by converting a name N3 into an initial, and dummy candidates “D.H.,” “K.S.,” “H.I.,” “S.T.,” “K.U.,” and “T.K.,” as the candidate attribute information 62.

As another example, the attribute information 57 may be information indicative of an address, a phone number, or other attributes of the user 11 instead of the name of the user 11. The candidate attribute information 62 may be information that simplifies a plurality of addresses, phone numbers, or other attributes instead of information indicative of a plurality of initials.

Processes from step S215 to step S219 are executed by the operation support device 40 of the vehicle 12.

In step S215, the controlling portion 41 receives the pieces of information on the getting-off position and the attribute, the information on the candidate destinations, and the information on the candidate attributes that are transmitted in step S214, from the operation management device 30 through the communication portion 43.

More specifically, the controlling portion 41 receives the getting-off position information 52, the attribute information 57, the candidate destination information 61, and the candidate attribute information 62 from the operation management device 30 through the communication portion 43. The controlling portion 41 stores the getting-off position information 52, the attribute information 57, the candidate destination information 61, and the candidate attribute information 62 thus received in the storage portion 42.

In step S216, the controlling portion 41 outputs, through the output portion 46, the information on the candidate destinations and the information on the candidate attributes that are received in step S215.

More specifically, as illustrated in FIG. 11, the controlling portion 41 outputs, to the in-vehicle display included in the output portion 46, the selection screen 60 on which the names of the eight candidate destinations indicated by the candidate destination information 61 stored in the storage portion 42 and the eight candidate attributes indicated by the candidate attribute information 62 stored in the storage portion 42 are displayed in parallel with respect to the person boarding the vehicle 12.

In step S217, the controlling portion 41 receives, through the input portion 45, an operation by the person boarding the vehicle 12 to select one candidate destination from the information on the candidate destinations that is output in step S216 and an operation by the person to select one candidate attribute from the information on the candidate attributes that is output in step S216. The controlling portion 41 acquires pieces of information on the selected candidate destination and the selected candidate attribute.

More specifically, the controlling portion 41 acquires information indicative of a name of the candidate destination selected by the person boarding the vehicle 12, on a touchscreen included in the input portion 45, from among the names of the eight candidate destinations displayed on the selection screen 60 output to the in-vehicle display, and the controlling portion 41 also acquires information indicative of the candidate attribute selected by the person boarding the vehicle 12, on the touchscreen, from among the eight candidate attributes displayed on the selection screen 60. The controlling portion 41 stores the pieces of information thus acquired in the storage portion 42.

In step S218, the controlling portion 41 compares the pieces of information on the candidate destination and the candidate attribute that are acquired in step S217 with the pieces of information on the getting-off position and the attribute that are received in step S215.

More specifically, the controlling portion 41 compares the information indicative of the name of the candidate destination selected by the person boarding the vehicle 12, the information being stored in the storage portion 42, with the getting-off position information 52 stored in the storage portion 42, and the controlling portion 41 also compares the information indicative of the candidate attribute selected by the person boarding the vehicle 12, the information being stored in the storage portion 42, with the attribute information 57 stored in the storage portion 42.

In step S219, the controlling portion 41 executes a process corresponding to a comparison result in step S218. In the present embodiment, when a pair of the candidate destination and the candidate attribute indicated by the pieces of information acquired in step S217 matches a pair of the getting-off position and the attribute indicated by the pieces of information received in step S215, the controlling portion 41 notifies the driver of the vehicle 12 that the user 11 who has made the reservation has boarded the vehicle 12. In the meantime, when the pair of the candidate destination and the candidate attribute indicated by the pieces of information acquired in step S217 does not match the pair of the getting-off position and the attribute indicated by the pieces of information received in step S215, the controlling portion 41 notifies the driver of the vehicle 12 that a person different from the user 11 who has made the reservation has boarded the vehicle 12.

More specifically, when a pair of the name of the candidate destination and the candidate attribute that are selected by the person boarding the vehicle 12 and indicated by the pieces of information stored in the storage portion 42 matches a pair of the name of the getting-off position indicated by the getting-off position information 52 stored in the storage portion 42 and the initial indicated by the attribute information 57 stored in the storage portion 42, the controlling portion 41 outputs, to the driver of the vehicle 12 through the output portion 46, a message indicating that the user 11 who has made the reservation has boarded the vehicle 12. In the meantime, when the pair of the name of the candidate destination and the candidate attribute that are selected by the person boarding the vehicle 12 and indicated by the pieces of information stored in the storage portion 42 does not match the pair of the name of the getting-off position indicated by the getting-off position information 52 stored in the storage portion 42 and the initial indicated by the attribute information 57 stored in the storage portion 42, the controlling portion 41 outputs, to the driver of the vehicle 12 through the output portion 46, a message indicating that a person different from the user 11 who has made the reservation has boarded the vehicle 12.

In the example of FIG. 11, the getting-off position information 52 is information indicative of “Roppongi HLS” and “Nishiazabu” as respective names of the getting-off position P2 and the getting-off position P5. The attribute information 57 is information indicative of “H.K.” and “S.K.” as respective initials of the name N1 and the name N3. Meta information indicating that “Roppongi HLS” is paired with “H.K.” and “Nishiazabu” is paired with “S.K.” is given to the getting-off position information 52 and the attribute information 57. Accordingly, when the pair of the name of the candidate destination and the candidate attribute that are selected by the person boarding the vehicle 12 is either of the pair of “Roppongi HLS” and “H.K.” and the pair of “Nishiazabu” and “S.K.,” the driver of the vehicle 12 is notified that the person is the user 11 who has made the reservation. In the meantime, when the pair of the name of the candidate destination and the candidate attribute that are selected by the person boarding the vehicle 12 is not either of the pair of “Roppongi HLS” and “H.K.” and the pair of “Nishiazabu” and “S.K.,” the driver of the vehicle 12 is notified that the person is not the user 11 who has made the reservation.

In the present embodiment, when a person boards the vehicle 12, the candidate destination selected by the person is compared with the getting-off position associated with the boarding position corresponding to the position of the vehicle 12, and further, the candidate attribute selected by the person is compared with the attribute associated with the boarding position corresponding to the position of the vehicle 12. Hereby, it is possible to more accurately check whether the person is the user 11 who has made the reservation or not, regardless of whether the person carries communications equipment such as a wireless tag or not.

In the present embodiment, the attribute such as the name of the user 11 is simplified and output as candidate attribute information instead of being output as candidate attribute information without any change. Hereby, privacy or personal information of the user 11 can be protected.

As one modification of the present embodiment, the database 50 may be constructed in the storage portion 42 of the operation support device 40. In this case, in step S113, the reservation ID 56, the vehicle ID 55, the boarding position information 51, the getting-off position information 52, the boarding time information 53, the getting-off time information 54, and the attribute information 57 are registered in the database 50 of the operation support device 40 of the vehicle 12 arranged in step S112. The processes from step S212 to step S215 are omitted. Similarly to the process in step S214, the controlling portion 41 of the operation support device 40 searches the database 50 by use of, as a search key, a pair of the boarding position information 51 corresponding to the two-dimensional coordinates or three-dimensional coordinates of the current position of the vehicle 12 and the vehicle ID 55 and also generates the candidate destination information 61 and the candidate attribute information 62, so that the controlling portion 41 acquires information necessary for the processes from step S216 to step S218.

As one modification of the present embodiment, the operation support device 40 may be constituted as a server belonging to a cloud computing system or other computing systems. The operation support device 40 may be integrated with the operation management device 30. In this case, the processes of step S211, step S212, step S215, step S216, and step S219 are executed by the vehicle 12. The process of step S218 is executed by the server. In step S214 and step S215, among the pieces of information on the getting-off position and the attribute, the information on the candidate destinations, and the information on the candidate attributes, only the information on the candidate destinations and the information on the candidate attributes are transmitted to the vehicle 12 from the server. In step S217, pieces of information on the selected candidate destination and the selected candidate attribute are uploaded to the server from the vehicle 12. In step S218, a comparison result is transmitted to the vehicle 12 from the server.

The present disclosure is not limited to the above embodiments. For example, a plurality of blocks described in the block diagram may be integrated, or one block may be divided. Instead of sequentially executing a plurality of steps described in the flowchart in accordance with the description, they may be executed in parallel or in a different order in accordance with processing capacities of the devices that execute respective steps or as necessary. Furthermore, the present embodiments may be variously modified without departing from the gist of the present disclosure.

What is claimed is:

1. An operation support device for supporting an operation of a vehicle for which an operation plan is determined in accordance with a boarding position and a getting-off position requested by a reservation, the operation support device comprising a controlling portion configured such that, when one candidate destination is selected or input by a person who boards the vehicle at the boarding position in the vehicle stopping at the boarding position, the controlling portion acquires information on the one candidate destination thus selected or input and compares the acquired information with information on the getting-off position that is associated with information on the boarding position at a time of making the reservation.

2. The operation support device according to claim 1, wherein, when one candidate destination is selected by the person who boards the vehicle at the boarding position from information on a plurality of candidate destinations that is output in the vehicle stopping at the boarding position, the controlling portion acquires information on the one candidate destination thus selected and compares the acquired information with the information on the getting-off position that is associated with the information on the boarding position at the time of making the reservation.

3. The operation support device according to claim 2, wherein the information on the candidate destinations includes information on a simplified name or address of the getting-off position as information on a candidate destination corresponding to the getting-off position.

4. The operation support device according to claim 2, wherein:
an attribute of a user planned to board the vehicle is designated at the time of making the reservation; and
when one candidate attribute is selected by the person who boards the vehicle at the boarding position from information on a plurality of candidate attributes that is output in the vehicle stopping at the boarding position in addition to the selection of the one candidate destination, the controlling portion acquires the information on the one candidate destination thus selected and information on the one candidate attribute thus selected, and the controlling portion compares the acquired information on the one candidate destination thus selected with the information on the getting-off position that is associated with the information on the boarding position at the time of making the reservation and compares the acquired information on the one candidate attribute thus selected with information on the attribute that is associated with the information on the boarding position at the time of making the reservation.

5. The operation support device according to claim 4, wherein the information on the candidate attributes includes information obtained by simplifying the attribute as information on a candidate attribute corresponding to the attribute.

6. The operation support device according to claims 2, wherein the information on the candidate destinations includes information on a dummy candidate that does not correspond to the getting-off position.

7. The operation support device according to claim 6, wherein:
the vehicle is a ride-sharing vehicle; and
in a case where there is a plurality of reservations having the same boarding position and different getting-off positions, the information on the candidate destinations includes information on a candidate destination that does not correspond to any of the getting-off positions of the reservations as the information on the dummy candidate.

8. The operation support device according to claim 1, wherein, when the candidate destination indicated by the acquired information does not match the getting-off position, the controlling portion notifies a driver of the vehicle that a person different from a user who has made the reservation has boarded the vehicle.

9. The operation support device according to claim 1, wherein:
the vehicle is a ride-sharing vehicle; and
the controlling portion compares the number of people who board the vehicle at the boarding position with the number of people who have made reservations having the same boarding position and notifies the driver of the vehicle of a comparison result.

10. A vehicle comprising the operation support device according to claim 1.

11. An operation management device comprising:
a communication portion configured to transmit and receive information; and
a controlling portion configured to receive, through the communication portion, position information of a vehicle for which an operation plan is determined in accordance with a boarding position and a getting-off position requested by a reservation, the position information of the vehicle being transmitted from the vehicle during stop at the boarding position, the controlling portion being configured to transmit, through the communication portion in response to the position information of the vehicle, information on the getting-off position that is associated with information on the boarding position corresponding to the position information of the vehicle at a time of making the reservation and information on a plurality of candidate destinations including information on a candidate destination corresponding to the getting-off position.

12. An operation support method comprising:
outputting information on a plurality of candidate destinations by a vehicle for which an operation plan is determined in accordance with a boarding position and a getting-off position requested by a reservation, the information being output by the vehicle during stop at the boarding position;
when one candidate destination is selected by a person who boards the vehicle at the boarding position from the information output by the vehicle, acquiring, by an operation support device, information on the one candidate destination thus selected; and
comparing, by the operation support device, the information thus acquired with information on the getting-off position that is associated with information on the boarding position at a time of making the reservation.
